(19) United States
(12) Patent Application Publication
(10) Pub. No.: US 2009/0031407 A1
(43) Pub. Date: Jan. 29, 2009

(54) Method and system for security check or verification

(76) Inventor: Shaobo Kuang, Lansdale, PA (US)

Correspondence Address: SHAOBO KUANG, 1243 Meadowview Circle, Lansdale, PA, 19446, US

(21) Appl. No.: 12/217,385

(22) Filed: Jul. 5, 2008

Related U.S. Application Data
(60) Provisional application No. 60/961,712, filed on Jul. 24, 2007.

(51) Int. Cl. H04L 9/32; G06F 21/00

(52) U.S. Cl. 726/7

(57) ABSTRACT

An security check or verification method includes generating at least one verification code or number for each user at a security check/verification server, sending the generated verification code or number to user's dedicated mobile device though a secured connection, entering the verification code when user login to a web site, sending the verification code or number to the security check server from the web site server, allowing the user access based on the correct user name, password, and the confirmation form the security check server.

### RELATED APPLICATION

The present invention is based on the provisional Patent Application Ser. No. 60/961,712, filed on Jul. 24, 2007, titled “Method and System for Security Check or Verification”

### FIELD OF THE INVENTION

The present invention relates to a method and a system for security check or verification, more specifically, a method and a system for verifying a user/customer who tries to login to a system, such as on-line trading or shopping system, and for verifying a user/customer who is in possession of a legitimate card (credit card, debit card or the like) at the time of an order.

### BACKGROUND OF THE INVENTION

The wide use of credit/debit/money cards for general money transactions has recently proliferated throughout the world. Along with many benefits and ease of use, these inexpensive and readily available cards are also highly susceptible to unauthorized use and theft. Security depends on maintaining personal possession of the cards and minimizing access to the account numbers as much as possible. However, with the increasing popularity of on-line payment, it is impossible the keep the credit card account number undisclosed. Therefore, easy and reliable means to help validate that a customer/user is in possession of a legitimate card (credit card, debit card, or the like) are needed. For some time, credit card companies have been using an extra three or four digit code to authorize credit card charges. Since they do not have the customer's plastic card when he pays on-line or by phone, they need this additional code. This additional digit code is sometimes called the Card Security Code (CSC) or the Card Verification Value or Code (CVV or CVC). The Card Security Code or Card Verification Value provides additional level security for credit or debit card transactions, especially for on-line transactions, increasing protection against credit card fraud. The CSC or CVV usually is not included in transactions during which the card is used directly face to face, and it will not be shown on a receipt. For indirect transactions, like on-line payments, phone orders, or mail orders, the CSC or CVV provides additional level protection, after the account number, to the cardholder.

AMEX's code is a four-digit number on the front of the card above the credit card number. The code will appear on either the right or the left side of the card. Visa's Card Verification Value (CVV) is a three-digit number on the back of the card. The full credit card number is reprinted in the signature box and at the end of the number is CVV. MasterCard's Card Validation Code (CVC) is a three-digit number on the back of the card.

Studies show that sales that include CSC or CVC validation in authorization procedures for indirect transactions result in a reduced number of fraud-related charge backs.

However, credit/debit cards are effective for 2 to 5 years. During this long time period, the CSC or CVC remains unchanged, and the credit card number and the CSC or CVC are passed together through the Internet over and over with the transactions made by the cards holders. Once the credit card number and its CSV or CVC are disclosed to a theft or a criminal group, the CSC or CVC will lose its security feature.

Widespread fraud has pushed banks and government regulators to look at ways to strengthen security for online banking or online credit/debit card payment systems. One of the criminal frauds is called a phishing scam, in which a criminal sets up faked banking sites or sends e-mails that attempt to trick people into divulging their usernames and passwords, or their credit card numbers and their CSC or CVC codes. Some other criminal frauds use a computer virus or the like technology to run a small code in the users computers, and steal the user's information, such as the users bank/credit card account, and their passwords or check numbers.

In order to defeat these frauds, many technologies have come out. One of them is RSA SecruID, which is a mechanism, developed by RSA Security for performing two-factor authentication to a user to a network resource. A user authenticating to a network resource needs to enter both a personal identification code and the number being displayed at that moment on their RSA SecurID token. The server, which also has a real-time clock and a database of valid cards with the associated seed records, computes what number the token is supposed to be showing at that moment in time, checks it against what the user entered, and makes the decision to allow or deny access. Recently, VeriSign Inc has begun to offer bankcards with integrated one-time password generators, which are similar to the above SecurID product. However, this technology requires the user/customer to hold a special hardware, which generates a real-time code to be recognized by the server. The cost of issuing/maintaining/replacing this kind of hardware is very high. Therefore this kind of technology is now more likely used among people like system administrators rather than the normal employees. Also, if a person has more than one bank card or credit card, he needs to hold more than one this kind of battery powered card or key chain.

Now, many companies or government agencies hire a quite number of short-term consultants. Most of these remotely log into the company's or the agency's computer systems, and help them to solve the problems. It is not convenient/effective to use the above SecurID typed card to manage/maintain the security for those kind of short-term workers.

Also, for watching TV or video online, there is always required to verify a user/movie. In another words, we need to verify that a user is allowed or permitted to watch a movie at a certain time.

The prior art technology didn't provide a simple and effective solution or answer to the above-mentioned security issues. Therefore, for credit cards, CSC or CVC, which is printed on the cards, is still the most widely used method for security check or verification for on-line shopping or phone order or mail order. When people login to your account, such as your eBay or eTrade account, their passwords are the only security check/verification. If someone steals your password, he is able to steal everything from your account.

### SUMMARY OF THE INVENTION

It is therefore the objects of the present invention are intended to overcome the drawbacks of the conventional art.

Accordingly, an object of the present invention is to provide a method and a system to help validate a customer/user is in possession of a legitimate card (credit card, debit card, or the like) for those indirect (not face to face) transactions, such as online payment or phone order or mail order.

Accordingly, another object of the present invention is to provide a method and a system to help validate a customer/user is the real owner of an account when he tries to login to this account.

Accordingly, another object of the present invention is to provide a simple and effective method and a simple and effective system to help validate a customer/user is in possession of a legitimate card (credit card, debit card, or the like) for those indirect (not face to face) transactions, such as online payment, phone order, or mail order.

Accordingly, another object of the present invention is to provide a simple and effective method and a simple and effective system to help validate a customer/user is the real owner of an account when he tries to login to this account through Internet.

Accordingly, another object of the present invention is to provide a simple and effective method and a simple and effective system to help validate a customer/user is in possession of a legitimate card (credit card, debit card, or the like) for those indirect (not face to face) transactions, such as online payment or phone order or mail order. The method and the system do not require the customer/user to carry many key chains or battery powered card(s) for their different types credit or debit cards.

Accordingly, another object of the present invention is to provide a simple and effective method and a simple and effective system to help validate a customer/user is the real owner of an account when he tries to login to this account. The method and the system do not require the customer/user to carry many key chains or battery powered cards for their different login accounts, such as eTrade, eBay, or their bank accounts.

Accordingly, another object of the present invention is to provide a simple and effective method and a simple and effective system to help validate a customer/user is in possession of a legitimate card (credit card, debit card, or the like) for those indirect (not face to face) transactions, such as online payment or phone order or mail order. The method and the system do not require the customer I user to carry many key chains or battery powered card(s) for their different types credit or debit cards. The method and the system issue a user verification code that may vary from time to time in order to be more difficulty broken by the on-line thefts.

Accordingly, another object of the present invention is to provide a simple and effective method and a simple and effective system to help validate a customer/user is the real owner of an account when he tries to login to his account The method and the system do not require the customer/user to carry many key chains or battery powered cards for their different login accounts, such as eTrade, eBay, or their bank accounts. The method and the system issue a user verification code that may vary from time to time in order to be more difficulty broken by the on-line thefts.

Accordingly, another object of the present invention is to provide a simple and effective method and a simple and effective system to help validate a random/short-term customer/user is the real owner of an account when he try to login to this account. The method and the system are able to active or de-active the user's validation/verification account in quick and effective way without issuing a battery powered card or key chain.

Accordingly, another object of the present invention is to provide a simple and effective method and a simple and effective system to help validate a customer/user who is legally allowed to watch a movie/video.

Accordingly, another object of the present invention is to provide a method and a system to allow people to identify their friends on line.

Accordingly, another object of the present invention is to provide a method and a system to allow people to notice their friends when they are online.

Further objects and advantages of our invention will become apparent from a consideration of the drawings and ensuring descriptions.

A security check or verification method according to the present invention includes:

generate at least one verification code or number for each account/user, and store them at a security check/verification server;

send the verification code value to the account/user dedicated device, such as user's cell phone, or his blackberry, or the like;

when a user logs into an on-line systems through Internet, in addition to user name and password, a user verification code, which he got from his dedicated device, such as his cell phone or blackberry, is required;

in addition to normal password check/verification, the user verification code value and the user's account or id are send to the said security check/verification server for verification through a secured connection;

the on-line system will allow the user access only when both then entered password and the entered verification code are correct.

A security check or verification method according to the present invention includes:

generate at least one verification code or number for each account/user at a security check/verification server;

send the verification code value to the account/user dedicated device, such as user's cell phone or blackberry, or the like;

when a user try to pay by his credit card through Internet, in addition to credit card number, a user verification code, which he got from his dedicated device, such as his cell phone or blackberry, is required;

in addition to normal credit card number check/verification, the user verification code value is send to the said security check/verification server for verification through a secured connection;

the credit card taking system will accept the user's credit card only when both regular credit card authorization and the entered verification code are accepted.

A security check or verification method according to the present invention further include the steps:

timely, or every time after a success verification, or at a predefined time, generate at least one verification code or number for each account/user at a security check/verification server;

send the verification code value to the account/user dedicated device, such as users cell phone or blackberry;

A security check or verification system according to the present invention includes a security check/verification server wherein the said security check/verification server further includes

means for generating at least one verification code or number for each account/user;

means for storing the said verification code or number for each account/user;

means for sending the generated verification code or number to the account/user dedicated device, such as his cell phone or blackberry device;

means for comparing the user/customer entered the verification code or number with the verification code or number stored at the server for each account/user;

means for sending the allowing or denying instructions to the requesting party based on the said comparing;

### BRIEF DESCRIPTION OF THE DRAWINGS

FIG. 1 is a schematic drawing showing an example system in accordance with the present invention.

FIG. 2 is a schematic drawing showing another example system in accordance with the present invention.

FIG. 3 is a schematic drawing showing an example of a user verification system in accordance with the present invention.

FIG. 4 is a flowchart showing a method of user verification in accordance with the present invention.

FIG. 5 is a flowchart showing an example of sending the generated verification to the user's dedicated device.

FIG. 6 architecturally shows a movie/video broadcasting system according the present invention.

FIG. 7 architecturally shows a user dedicated cell phone or the like according the present invention.

### DETAILED DESCRIPTION OF THE INVENTION

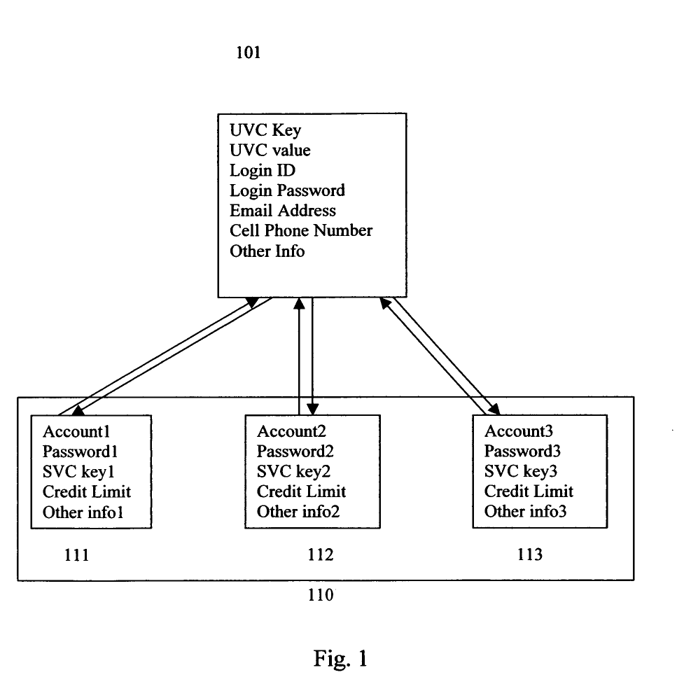

Referring now to the drawings, FIG. 1 shows a security check/verification system in accordance with the present invention. 101 are User Verification System (UVS), 111, 112 and 113 are the part of the account/customer information in a regular credit card authorization system 110. The credit card authorization system 110, further, for each customer/user, holds/stores a unique User Verification Code (UVC) Key. UVS 101 holds/stores User Verification Code (UVC) keys and the User Verification Code.

When a customer/user goes online shopping, he or she will enter his or her credit/debit card number, and a User Verification Code (similar to the above CSC or CVC), which may be a combination of numbers and/or letters, such 1423 or BcYm3. Sometimes, customers/users are also required to enter their credit card expiration date. Then he or she clicks the submit button (or other similar button) or presses the enter key. Normally, the online shopping site/system will send the credit card account number, amount to be charged, and the User Verification Code to a credit card authorization system 110 through Internet connection, more likely through a secured Internet connection. The credit card authorization system, based on the credit card account number, finds the corresponding UVC key. The credit card authorization system, then, sends the found UVC key and the customer/user entered UVC value to a User Verification System 101. The User Verification System 101 will validate whether or not the customer/user entered user verification code value matches with the stored UVC value with the same UVC key. The User Verification System 101 will send a signal back to the credit card authorization system 110, indicating the customer/user entered UVC value correct or not correct. If the charged amount is allowed and the user verification code (UVC) value is correct, then the credit card authorization system 110 will authorize the transaction. Otherwise, it will deny the transaction.

Although, FIG. 1 only shows one User Verification System (UVS) 101, and one credit card authorization system 110, there could be more than one UVS, and more than one credit card authorization system. In FIG. 1, each UVC value in User Verification System (UVS) 101 may vary from time to time, such as daily or hourly, or may vary after every validation. Although the user may login to User Verification System to see their new UVC value, it is preferred to use a more secure way to notify the user his new UVC value. For example, it will send the new UVC value to user through secured/encrypted email. According to the present invention, a better way is to send the new UVC value, through a secured network connection, to a user dedicated device, such as user's mobile device, like their cell phone, blackberry, their PDA, or the like. Since only the cell phone or the device holder, who is also the credit/debit cardholder, is able to get and enter the newly generated UVC value, the credit card authorization system is able to check/verify that the web/net user is the real cardholder.

For different purposes, a person may have more than one UVC key from one or more User Verification Systems (UVS). Therefore, he or she will have one or more User Verification Code (UVC) values. According to the present invention, all these UVC values will be stored in and displayed from one single user dedicated device, such as a cell phone, blackberry, PDA or other mobile device. Therefore, there is no need for the user to carry many RSA SecurID liked cards.

Also, according to the present invention, the user's different products can share the UVC key. For example, user's credit card, debit card, and his Etrade account can share one UVC key. In another words, all the verifications for his credit card, debit card and his Etrade account will go to the same verification server.

The user verification code (UVC) key, in FIG. 1, is preferred to include 2 portions, UVS server identifier portion and the user identifier portion. The UVS server identifier may be an IP address, universal name space, or the like. The user identifier portion may be user ID or the like in UVS. Therefore, by UVC key, the on-line trading system is able to send the user ID and entered UVC value to the right server for check/verification

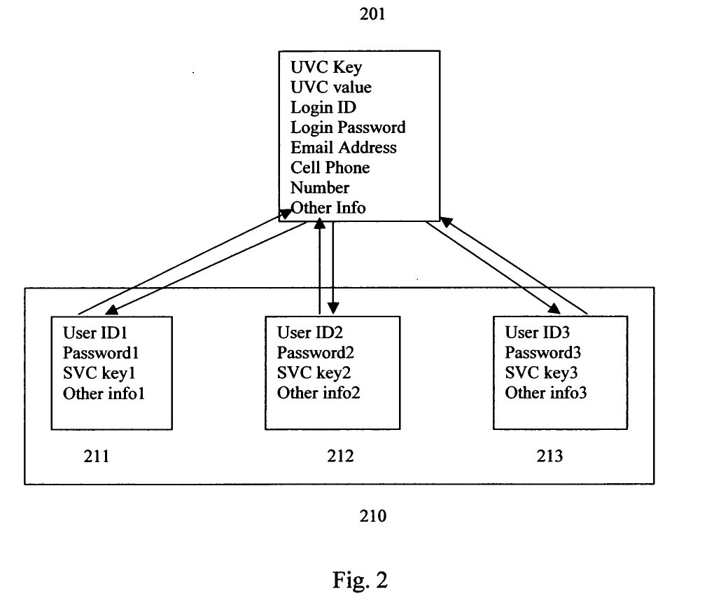

FIG. 2 shows another security check/verification system in accordance with the present invention. 201 are User Verification System (UVS), 211, 212 and 213 are user accounts in a regular Internet system 210, such as eTrade or eBay, or regular computer system, such as the server in a company, or even a personal PC. When people try to access the system 210, login id/name and password are required. Computer system 210, further holds/stores a unique User Verification Code (UVC) Key for each user. UVS 101 holds/stores User Verification Code (UVC) keys and the User Verification Code values.

When a user tries to login into the system 210, through Internet or remote, he or she will enter the user id/name, the password, and the User Verification Code (similar to the above CSC or CVC),), which may be a combination of numbers and/or letters, such 5423 or BcYm3. Then he or she clicks the submit button (or other similar button) or presses the enter key. Normally, the system 210 will validate the user id/name and the password based on their profile 211, 212, and 213. If the user id name and the password are correct, system 211, 212 or 213, based on user id/name, finds the corresponding UVC key. The system 210, then, sends the found UVC key and the customer/user entered UVC value to a User Verification System 201. The User Verification System 201 will validate whether or not the customer/user entered user verification code value matches with the stored UVC value with the same UVC key. The User Verification System 201 will send a signal back to the system 210, indicating the customer/user entered UVC value correct or not correct. If the entered user id/name, the password, and the verification code (UVC) value are all correct, then the system 210 will authorize the access. Otherwise, it will deny the access. The method or system can also be applied to the transaction level, to allow or deny the transaction by verifying the UVC value. For example, the user successfully logs into a trading system, such eTrade or eBay. Then, every time he tries to make a transaction, such as buy a stock, he is required to enter the newly generated UVC value, which he receives from his cell phone or the like. The transaction will be accepted only when he enters a correct UVC value.

Although, FIG. 2 only shows one User Verification System (UVS) 201, only one system 210, there could be more than one UVS, more than one computer systems. For example, one is UVS from your credit card company, and another one is UVS form your own company's system. In FIG. 2, each UVC value in User Verification System (UVS) 201, may vary from time to time, such daily or hourly, or may vary after every validation. Although the user may login to User Verification System to see their new UVC value, it is preferred to use a more secure way to notify the user their new UVC value. For example, it will send the new UVC value to user through secured/encrypted email. According to the present invention, a better way is to send the new UVC value, through a secured network connection, to a user dedicated device, such as user's cell phone, blackberry, their PDA, or the like. Since the newly generated UVC value is sent to the user's dedicated device, only the real user is able to enter the correct UVC value. Therefore, the user check/verification system is able to check/verify that the user is the real account holder.

For different purposes, a person may have more than one UVC keys from one or more User Verification Systems (UVS). Therefore, he or she will have one or more User Verification Code (UVC) values. All these UVC values will be stored in and displayed from one single device, his or her cell phone, blackberry, PDA or other mobile devices.

The user verification code (UVC) key, in FIG. 1, is preferred to include 2 portions, UVS server identifier portion and the user identifier portion. The UVS server identifier may be an IP address, universal name space, or the like. The user identifier portion may be user ID in UVS.

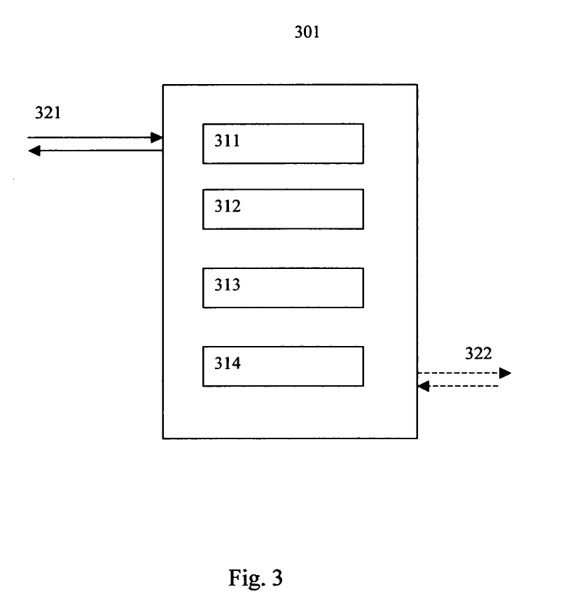

FIG. 3 shows an example of a user verification system according to the present invention. User Verification System (UVS) 301 includes a processor 311, storage means (312) for storing/holding user verification code (UVC) keys (or IDs) and the current corresponding UVC values, means (313) for generating a new UVC values, and means (314) for sending/notifying the new UVC values to the users. UVS 301 receives a verification request, through Internet/network connections 311, from an on-line shopping system or a credit card authorization system, or a secured trading system. The verification request includes a user verification code key (or ID) and a user verification value. Processor 311 then looks for the current UVC value in storage 312 based on the received UVC key (or ID), compares it with the received UVC value, and sends comparison result back to the said on-line shopping system or credit card authorization system, or secured trading system. The new UVC value generator 313 will, periodically or after verification, or after a successful verification, or at predefined time, generate a new UVC value randomly or based on certain rules. Then, 314 will, in a secured way/method, send/notify the new UVC value to the users email address, or preferred to the user's dedicated mobile device, such as user's cell phone, blackberry, PDA or the like. Then, the processor 311 will replace the old UVC value in storage 312 with the new UVC value. It is preferred that, before the overwriting the old UVC value in the storage 312, the system will wait for the confirmation that the new UVC value has been written to the user's device, such as cell phone, blackberry, PDA or the like, so that both UVS and the user's device have the same new UVC value. When shopping on line, the user can see the new UVC value from display screen in his device, and will use the new UVC value for verification. Since the new UVC value is dedicatedly sent to user's device through another connection, it is tougher for those on-line thefts to grab user's accounts, passwords, and the user's UVC values. Also, it is preferred that the UVC values in user's devices, such as cell phone, blackberry, or the like, are password protected. Therefore, even if he loses his wallet and his cell phone at the same time, his credit cards/money cards are still being protected in some extent.

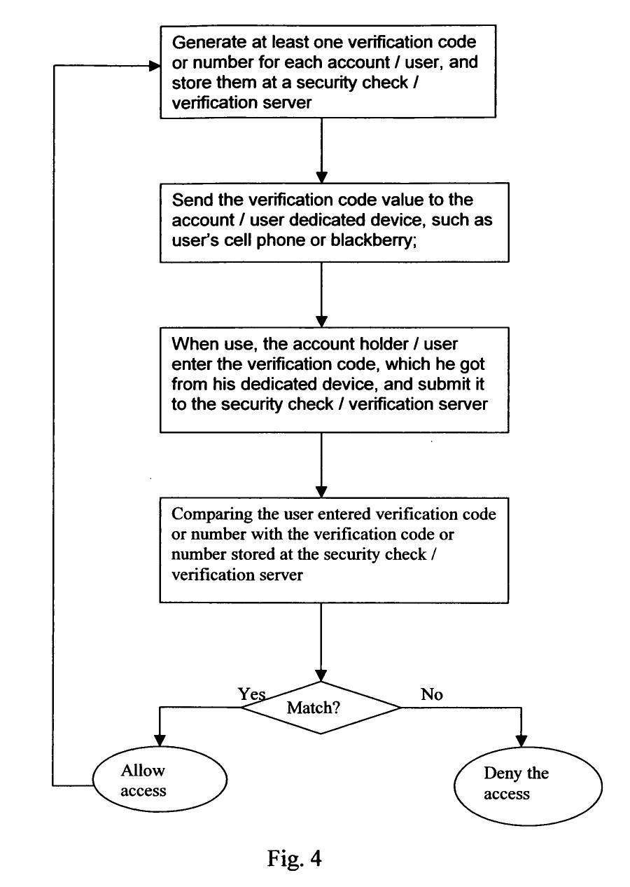

FIG. 4 is flowchart showing an example of a method of user verification in accordance with the present invention. The method shown in FIG. 4 includes the following steps:

Generate at least one verification code or number for each account/user, and store the code or number at a security check/verification server;

Send the verification code value to the account/user dedicated device, such as the user's cell phone, PDA, or blackberry device;

When use, such as log into a on-line trading system, or enter a credit card number, the account holder/user also enter the verification code, which he got from his dedicated device, and submit the verification code to the security check/verification server;

Upon the receiving the user entered verification code or number, the system on the security check/verification server will compare the user entered verification code or number with the verification code or number stored in the server for the account/user;

If match found, it then allow the access. Otherwise it will deny the access. After allowing the access, it may re-generate the verification code again;

In the above step a), the verification code or number for each account or user can be generated in many ways at any time. For example, the system will randomly generate the verification code daily, or randomly generate the verification code or number after a successful verification.

In the above step b), the verification code or number is preferred send to the users dedicated device (such as user's cell phone or blackberry device) through a secured network connection. It may only send the factor or a so-called seed of the verification code or number to the user's dedicated device. The system in the user's dedicated device can derive the users verification code or number the factor or the seed of the verification code. The user's dedicated device has universal unique identifier, such as a fixed IP address, or cell phone number, so that the security check/verification server will always send the verification code or number to the right account/user's dedicated device.

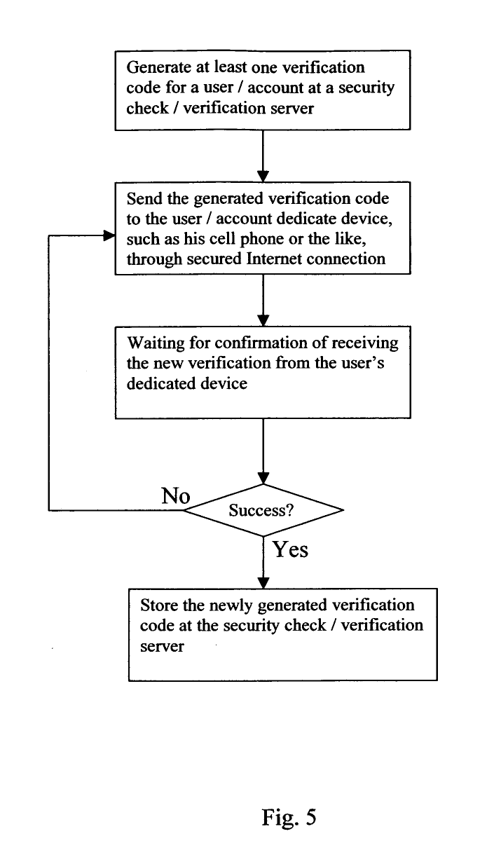

FIG. 5 is a flowchart showing an example of sending the generated verification to the user's dedicated device. First, generate at least one verification code for a user/account at a security check/verification server. Then, send the generated verification code to the user/account dedicate device, such as his cell phone or the like, through secured Internet connection. Then, wait for confirmation of receiving the new verification from the user's dedicated device. If get a successful confirmation, it will store the newly generated verification code at the security check/verification server for late security check/verification.

It is possible not to send the full verification code to the user's dedicated device, but send the partial or the factor or the seed of the generated verification code to the users dedicated device. The users dedicated device can derive the full verification code from those partial or the factor or the seed of the generated verification code.

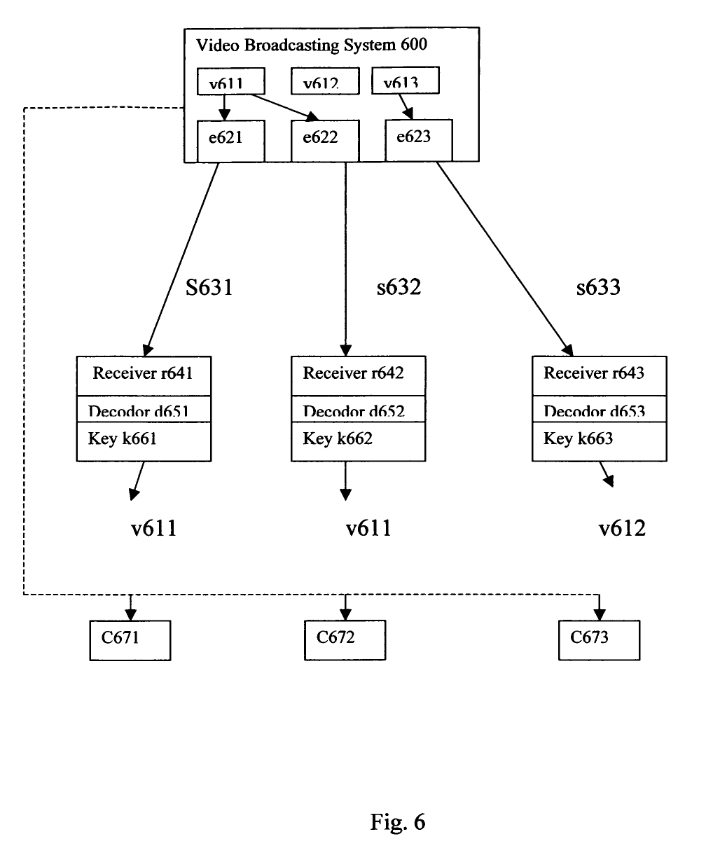

FIG. 6 architecturally shows a movie/video broadcasting system according the present invention. Movie/video broadcasting system 600 broadcasts video v611, v611, v613 through encoder e621, e622, and e623 to receivers r641, r642, and r643. The encoder e621, e622 and e623 encode the videos so that the receivers need the decoding keys k661, k662, and k663 to decode the received streams s631, s632 and s633 to the original videos v611, v612, and v613. The system, before or during the broadcasting, send the decoding keys k661, k662 and k663 to the customer/user's dedicated device, such user's cell phone c671, c672 and c673, or the like. When or before receiving the broadcasted stream, the user will enter their received keys k661, k662 and k663 from their dedicated device (for example, user's cell phone) c671, c672 and c673 to their decoders so the decoder d651, d652 and d653 are able to decode the received steams s631, s632 and s633 into the original videos v611, v611 and v613. In this case, the system will send the decoding keys to their accepted users, such as the users who paid for watching the videos. Also, the system can set up the decoding keys only effective for a certain periods, such as good for one day or one week, so that the spreading of the illegal copies/broadcasting is limited.

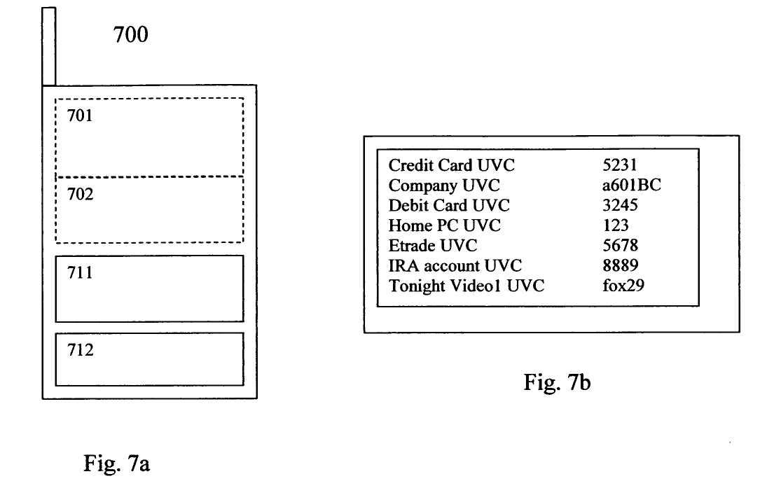

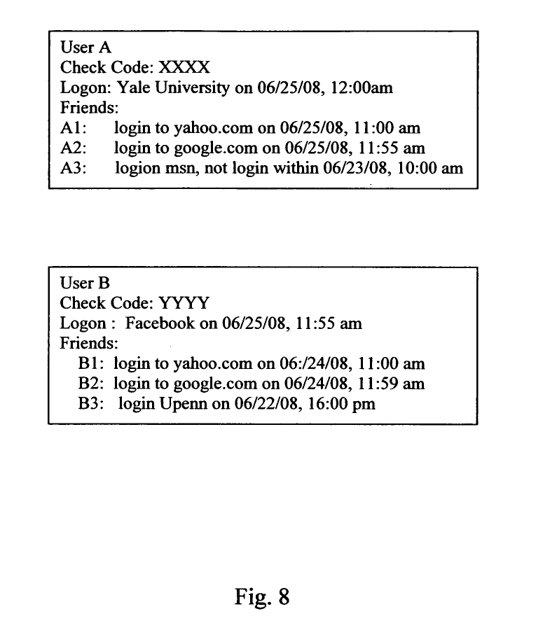

FIG. 7a architecturally shows a user dedicated cell phone or the like according the present invention. Cell phone 700 includes display screen 701, and other regular cell phone parts 702. Cell phone 700 further includes a storage means (711) for storing the received UVC value, and means (712) for allowing or disallowing the display the said stored UVC value. Storage means 711 further stores UVS server identifier so that when the cell phone receives UVC value, it knows what the value is for. Security means 712 can be a biometric device to only allow the cell phone holder to see the UVC value from screen 701. Therefore, even if the user loses his cell phone, his account is still safe.

FIG. 7b shows an example data stored in above mentioned storage means 711. In this example, the user holds 7 different UVC values for his 6 different products, which are his credit card, debit card, his company login, his home computer remote login, his eTrade account, his retirement IRA account, and a short term UVC or decode key for tonight video broadcasting from Fox channel. Therefore, beside the password protection, the present invention provides another layer security check (UVC check) to the user's 7 different products through the user's dedicated device, such as his cell phone or the like.

FIG. 8 shows an example of user profile stored in the security check or user verification server. User A has friends A1, A2 and A3 while user B has friends B1, B2 and B3. A1, A2, A3, B1, B2, and B3 all have accounts in the security check or user verification server. When user A, a student in Yale University, login his university network, his user verification account & check code (he got from his IPhone) are sent to a security check or user verification server. The security server looks at his profile, gets his friends logon data, and sends back the pass confirmation with his friends logon information back to Yale network. Yale network will show his friends logon information on his page. In this example, users will know his friends is on line or not, no matter where his friends in. In another words, Yahoo people will see his msn friends or his AOL friends on his buddy list.

Although the above detail descriptions contain many specifics for the purpose of illustration, one of ordinary skill in the art will appreciate that many variations and alterations to the above details are within the scope of the invention. Accordingly, the above embodiments of the invention are set forth without any loss of generality to, and without imposing limitations upon, the claimed invention.

1. A method for security check or user verification according to the present invention comprising:
under control of a security check or user verification server,
generating a security check or user verification code for a user account, and storing it,
sending the generated security check or user verification code to the user's dedicated mobile device, saving the code into the mobile device,
under control of a client system,
entering a user name and password for login to a web site;
entering a check or verification code, which is obtained from his or her mobile device;
submitting the entries;
in response to the submit, sending the entries to the hosting server for the web site the user try to login;
under control of a web site hosting server,
receiving the user name, password, and check or verification code,
finding, from the user profile, the corresponding the user account in said security check or user verification server,
sending the user account and the user entered check code to the said security check or user verification server to request security check or user verification,
under control of the security check or user verification server,
in response to the said security check or user verification request, finding the user account based on received user account,
comparing received the user security check or verification code with the stored user security or verification code,
sending the pass or failed confirmation based on the comparing result back to the said web site hosting server,
under control of the web site hosting server,
allowing or denying the user access based on the user name, password, and the confirmation form the security check or user verification server.

2. The method of claim 1 wherein the generating check or verification code includes periodically generating a security check or user verification code.

3. The method of claim 1 wherein the generating check or verification code includes generating a security check or user verification code every time after a successful confirmation.

4. A security check or verification system according to the present invention includes a security check/verification server wherein the said security check/verification server further includes:
means for generating at least one security check or verification code for each account/user;
means for storing the said security check or verification code for each account/user;
means for sending the generated security check or user verification code to the account/user dedicated device, such as his cell phone or blackberry device;
means for comparing the user/customer entered the security check or verification code with the corresponding security check or user verification code stored at the server for the account user for check or verification;
means for sending the pass or failed confirmation back to the requesting site based on the said comparing.

5. The system of claim 4 wherein the said generating means timely generates security check or verification code for each account/user; and sends the check or verification code to its user's mobile device through a secured wireless network connection.

6. The system of claim 4 wherein the system further includes a trigger means for trigger to generate security check or verification code for a account/user and send the check or verification code to its user's mobile device through a secured wireless network connection every time when a successful confirmation occurs for the account.

7. The system of claim 4 where the system further includes means for storing the user's friends and their logon information, so that every time when he login to a web site, he is able to see his friends logon information no matter his friends are in different web sites or using different web tools.

8. A method of security check or user verification according to the present invention comprising:
under control of a security check or user verification server,
generating a security check or user verification code for a user account, and storing it,
sending the generated check or verification code to the user's dedicated mobile device, saving the code into the mobile device,
under control of a video or movie playing system,
before or during the playing of a video or a movie, prompting for the user to enter id, which is related to a user account in the said security check or user verification server, and check or verification code, which is obtained from his mobile device,
sending the user account and the user entered check code to the said security check or user verification server to request security check or user verification,
under control of the security check or user verification server,
in response to the said security check or user verification request, finding the user account based on received user account,
comparing received the user security check or verification code with the stored user security or verification code,
sending the pass or failed confirmation based on the comparing result back to the said web site hosting server,
finding, from the user profile, the corresponding the user account in said security check or user verification server,
sending the user account and the user entered check code to the said security check or user verification server to request security check or user verification,
under control of the video or movie playing system,
allowing or denying the user to play the video or movie the based on the user name, password, and the confirmation form the security check or user verification server

9. The method of claim 8 wherein the generating check or verification code includes periodically generating a security check or user verification code.

10. The method of claim 8 wherein the generating check or verification code includes generating a security check or user verification code every time after a successful confirmation.
